(19) United States
(12) Patent Application Publication
(10) Pub. No.: US 2012/0239189 A1
(43) Pub. Date: Sep. 20, 2012

(54) Systems and Methods for Vending Machine Control Using a Digital Panel

(75) Inventors: Alexandre JAUD, Marseille (FR); Régis LE BRAS, ST Cyr Sur Mer (FR)

(73) Assignee: INTUI SENSE Sarl, Aubagne (FR)

(21) Appl. No.: 13/423,872

(22) Filed: Mar. 19, 2012

Related U.S. Application Data
(60) Provisional application No. 61/454,195, filed on Mar. 18, 2011.

(51) Int. Cl. G06F 17/30

(52) U.S. Cl. 700/236

(57) ABSTRACT

Methods and systems are disclosed for controlling and communicating with a multi-drop bus (MDB)-compatible vending machine. A system includes a selection module for selecting an item from an MDB-compatible vending machine using a digital panel display, such as a touch screen or a display of a remote portable device. The system includes control and monitoring modules. The selection module communicates with the vending machine without requiring direct access to a manufacturer's proprietary vending machine controller (VMC) via a communication system interpreting MDB protocol information from the VMC to a computing device in order to display change system and machine status information during the purchase process, as well as providing technical access to an operator and data collection to the vendor. In another embodiment, a method confirms a digital purchase order for a selected item and forwards the purchase order to a VMC. The method confirms and communicates item delivery status.

### CROSS-REFERENCE TO RELATED APPLICATIONS

The present application claims the benefit of U.S. Provisional Appl. No. 61/454,195 entitled “Digital Panel Display Control and Monitoring System for Item's Selection of MDB Compatible Automate Without Direct Access to the Vending Machine Controller,” filed Mar. 18, 2011. This prior application is incorporated by reference herein in its entirety.

### FIELD OF THE DISCLOSURE

The field of the disclosure relates generally to machine communications, and more particularly to communications methods and systems enabling indirect communications with multi-drop bus (MDB)-compatible vending machines capable of selecting items from a digital panel display such as, but not limited to, a mobile computer display, a touch screen, a smart phone display, and a tablet display.

### BACKGROUND

Advances in vending machine and mobile communication technologies have created tremendous opportunities, one of which is providing users of mobile computing devices an ability to initiate vending machine transactions using their mobile devices. One approach to enable mobile devices to conduct vending machine selections and payments is through the use of wireless protocols such as IEEE 802.15, Bluetooth®, ZigBee, and near field communication (NFC) technology to securely transmit item selection and payment information to a contactless terminal in a vending machine. To enable this, mobile phones that support one or more of the ZigBee, Bluetooth®, or NFC protocols/standards have been proposed. However, not all vending machines have vending machine controllers (VMCs) that can process chip data elements. For example, many vending machines have proprietary VMCs that can only accept item selection via physical buttons, switches, and payment via readers/scanners on the machines. As a result, a purchaser/user that has a Bluetooth®, ZigBee, or NFC-capable mobile device may not be able to use it to select or purchase items from vending machines with proprietary VMCs.

A multi-drop bus (MDB) is a computer bus in which all components are connected to the same set of electrical wires. A process of arbitration determines which device or component on the computer bus gets the right to be the sender of information at a given point in time. Other devices on the bus must listen for the data that is intended to be received by them. Multi-drop buses (MDBs) are used as a serial bus interface for electronically controlled vending machines.

An MDB is configured for Master-Slave operation wherein there is one Master with capability of communicating with up to thirty-two peripherals. The Master is defined as a VMC. MDBs are used by VMCs to communicate with components of the vending machine, such as a currency detector (i.e., a coin changer, card reader, or paper note/bill accepter). Vending machines using MDB buses communicate with the MDB protocol, an 8-bit serial protocol with an additional mode bit, wherein the mode bit differentiates between address and data bytes. The MDB protocol is supported by vending machine associations such as the National Automatic Merchandising Association and the European Vending Association and European Vending Manufacturers Association.

The MDB protocol is used in vending machines to interconnect different modules (such as bill acceptors, card readers and coin changers) with one bus. Traditional MDB-compatible vending machines interconnect their modules with a physical connection via an unmodulated serial bus with a fixed data rate of 9600 baud, and 9 bits in each data word transmitted. The MDB protocol has evolved as a standard vending machine protocol and allows alternative (e.g., Smartcard-based) payment systems to be connected to existing vending machines.

Although multi-drop buses (MDBs) have advantages of simplicity and extensibility, their frequencies are limited to around 200-400 MHz due to reflections on a wire from a printed circuit board (PCB) onto the die. MDBs also have distance constraints of approximately 10-20 centimeters.

MDB bus addressing is based on the device type, which allows for a very simple protocol stack as no initial enumeration needs to be performed. However, a disadvantage of MDB-compatible vending machines is that only one device of each type can be attached. Selecting items from traditional MDB-compatible vending machines requires use of buttons or switches, (i.e., with physical buttons/switches or via virtual buttons on a digital display panel or touch screen installed in the vending machine) and direct access to their VMCs. As a result, such machines cannot receive selections from remote devices.

Traditional vending machine item selection is handled by the VMC itself. Selection of items via panel buttons (i.e., physical buttons or switches on the machine) is communicated to the VMC via a physical relay connector developed by the manufacturer of the vending machine. A VMC communicates with change systems via the MDB protocol (for a MDB-compatible machine) in order to handle payment. Once payment is confirmed, the VMC delivers the product unless the item stack is empty or a mechanical issue occurs, in which case a change machine will be informed of the completion or not and will collect the change or refund.

Traditional vending machines use a light-emitting diode (LED) display to provide information regarding machine status and the purchase process such as price for a selected item, coins inserted, item availability/sold out status, error messages, and exact change required messages. However, with traditional vending machines, this information is directly controlled by the VMC and is not accessible to external devices or systems.

In traditional MDB-compatible machines (without digital panel displays aside from a small LED display), item prices are parameterized in the VMC via a panel buttons procedure with no possibility to automate the procedure with software as part of a digital based solution.

Newer vending machines include digital panel display such as touch screen enabling items selection to compare to physical, switch button selection. These machines, such as the Intel, Fuji and V-Sync, intelligent vending concept or Samsung uVending solution, with large screen displays, were designed with direct communication via proprietary protocols between the vending machine controller and the digital display.

These newer machines rely on manufacturers' agreement to access to proprietary information and/or communication protocol development. As such, they are limited to proprietary solutions and do not offer solutions for retrofitting of vending machines.

Indirect communication systems requires compliance with the MDB protocol. A solution interfacing between the VMC and a cashless system has been developed to enable cashless payment, such as PC2MDB™ cards from Upstate Network Corporation, allowing a computer to act as a slave device for existing VMCs. It allows a computer to act as a cashless payment device by using MDB protocol to communicate payment status to the VMC in order to unlock a delivery.

However, existing architectures dedicated to virtual payment do not provide secure and reliable information sufficient to collect payments and to display status information on vending machine LED displays, such as item inventory/availability information (i.e., indicating that a selected item is sold-out).

Data EXchange (DEX) is a data format for collecting audit and event data from vending machines. DEX-formatted communications enable auditing of vending machines and simplify inventory management for items ‘stocked’ in vending machines. DEX records can include data representing cash in/out information, product movement and other audit data. DEX output from traditional vending machines is communicated via standard protocol used to audit the machine and is the only way for MDB-compatible machines to have reliable data collection and parameterized prices from the VMC when there is no direct communication. DEX audits for traditional machines are usually done with an external device by using a jack output connector. A disadvantage of this manual procedure is that it stops use of the vending machine during the entire audit process because communication between the VMC and other devices is switched off. Thus traditional vending machines cannot be used by consumers while a data collection audit collects sales, price, and change information from the VMC.

In standard MDB-compatible machines (without a digital display) item prices are parameterized in the VMC via a panel buttons procedure with no possibility to automate the procedure with software as part of a digital based solution. Indeed, changing prices for such machines requires a technician to physically visit a machine to make the changes manually by using switch buttons which combination enables to access to a menu that includes prices setting for each stack of items.

A traditional way to set a price for a specific item consists in using the technical menu via physical buttons combination defined by each manufacturer and in checking the information via a small LED display which provides visual, real time feedback to the technician. The LED display is directly connected to the VMC and the feedback information provided and required to set a price is not made available by vending machine manufacturers.

Existing solutions with no direct communication with the VMC do not allow both payment and machine status information as direct communication does.

Accordingly, what is needed are systems and methods for controlling MDB-compatible vending machines by using a digital panel display without having to use physical buttons on the machine to select items and without having to directly access manufacturers' proprietary VMCs. What is further needed are systems and methods for controlling an MDB-compatible machine by using a remote digital panel display (such as a panel display on a smart phone) without requiring vending machine manufacturers to make significant changes to their VMCs. What is also needed are systems and methods for providing payment and machine status information.

### SUMMARY OF THE DISCLOSURE

Methods and systems are disclosed for controlling an MDB-compatible machine by using at least a digital panel display without having to use physical buttons or switches on the machine. In embodiments, the methods and systems communicate with MDB-compatible vending machines without having to directly access manufacturers' proprietary vending machine controllers (VMCs).

According to an embodiment, a system controls an MDB-compatible vending machine by using a remote digital panel display (such as, but not limited to, a touch screen of a smart phone) without using an added digital panel display or physical buttons to select items. In another embodiment, a method uses a remote digital panel display in conjunction with a digital display in a vending machine to communicate selection, payment, and order status for vending machine items.

Embodiments enable item selection and purchase using digital panel displays by retrofitting or using commercially-available “off the shelf” MDB-compatible machines.

In an embodiment, in addition to using an existing LED and/or digital panel display on an MDB-compatible machine, a system uses a remote digital panel display to provide real time vending machine controller (VMC) feedback to a consumer, such as, but not limited to, item prices, payment information, information regarding coins or bills inserted, and item availability (i.e., ‘sold out’ or ‘in stock’ status).

In another embodiment, an auditing system provides reliable and automatic data collection information from an embedded computer using the Data EXchange (DEX) protocol to provide a DEX audit.

In yet another embodiment, a system includes a digital panel display to enable item selection, a computing device configured to interpret both panel display selections and to automate communication of useful information, an input/output (I/O) relay card configured to translate virtual selections into explicable VMC information, an electronic monitoring board or card configured to collect data from a VMC. According to this embodiment, the system is capable of communicating with a change system and has a DEX connection to an auditing system. In accordance with this embodiment, the digital panel display can be a remote portable display such as, but not limited to, a smart phone, by combining the system with remote devices using existing communication protocols.

### BRIEF DESCRIPTION OF THE DRAWINGS

FIG. 1 is a block diagram of a communication system for an MDB-compatible vending machine, in accordance with an exemplary embodiment of the present disclosure.

FIG. 2 is a diagram of an LED display system, in accordance with an exemplary embodiment of the present disclosure.

FIG. 3 is a diagram of a price parameterization system, in accordance with an exemplary embodiment of the present disclosure.

FIG. 4 is a diagram of a direct communication system between a digital signage solution and a vending machine controller, in accordance with an exemplary embodiment of the present disclosure.

FIG. 5 is a diagram of an indirect communication system for payment, in accordance with an exemplary embodiment of the present disclosure.

FIG. 6 illustrates a price parameterization process, in accordance with an exemplary embodiment of the present disclosure.

FIG. 7 is a block diagram of a digital display communication architecture for MDB-compatible machines, in accordance with an exemplary embodiment of the present disclosure.

FIG. 8 is a block diagram of a contactless digital display communication architecture for MDB compatible machine, in accordance with an exemplary embodiment of the present disclosure.

FIG. 9 is a diagram of a system using a Y wire loom splitter in order to monitor MDB communications, in accordance with an exemplary embodiment of the present disclosure.

FIG. 10 depicts parameterization of machine and price numerical buttons, in accordance with an exemplary embodiment of the present disclosure.

FIG. 11 is a diagram of a system for providing door locking connector information, in accordance with an exemplary embodiment of the present disclosure.

FIG. 12 is a diagram of vending machine with an LED display control, in accordance with an exemplary embodiment of the present disclosure.

FIG. 13 is a diagram of a cashless payment system, in accordance with an exemplary embodiment of the present disclosure.

FIG. 14 depicts an MDB monitoring board, in accordance with an exemplary embodiment of the present disclosure.

FIG. 15 is a flowchart illustrating steps by which an LED display can provide vending machine feedback, in accordance with an exemplary embodiment of the present disclosure.

FIG. 16 is a flowchart illustrating steps by which a virtual LED display can provide vending machine feedback, in accordance with an exemplary embodiment of the present disclosure.

FIG. 17 depicts an example computer system in which embodiments of the present invention may be implemented.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

Embodiments disclosed herein include systems and methods for providing reliable, real time feedback to a consumer via a digital panel display. As used herein, “consumer”, “customer”, “end-user”, and “user” can be used interchangeably and can include any user making selections or purchases of items from a vending machine. Unless specifically stated differently, in an embodiment, an end-user is interchangeably used herein to identify a human consumer, a software application, or a group of consumers and/or software applications executed by one or more consumers to conduct item selection and purchase transactions from vending machines. Besides a human consumer who can select and purchase items from a vending machine, a software application can be used to make item selections and purchases. Accordingly, unless specifically stated, the terms “consumer”, “customer”, “end-user”, and “user” as used herein do not necessarily pertain to a human being.

Similarly, “technician”, “operator”, “vendor”, “administrator”, and “auditor” can be used interchangeably and can include any service technician or operator needing feedback, status, or audit information from a vending machine. Unless specifically stated differently, in an embodiment, a technician is interchangeably used herein to identify a human technician, a software application, or a group of technicians and/or software applications executed by one or more technicians to receive feedback, status, inventory information, and audits from vending machines. Besides a human technician who needs feedback from a vending machine, a software application can be used to retrieve audits and feedback from vending machines. Accordingly, unless specifically stated, the terms “technician”, “operator”, “vendor”, “administrator”, and “auditor” as used herein do not necessarily pertain to a human being.

### STRUCTURAL EMBODIMENTS

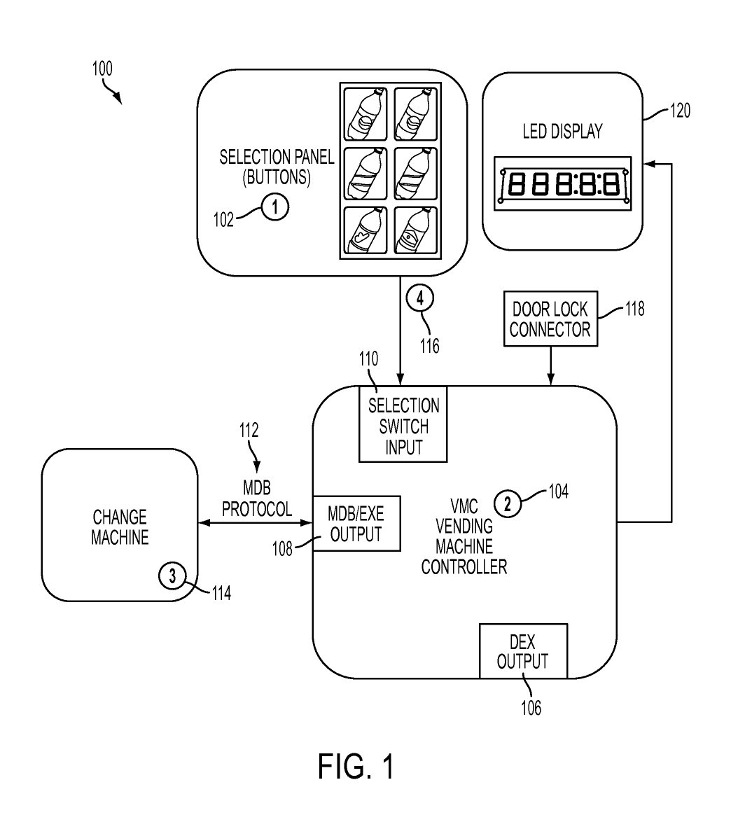

FIG. 1 is a block diagram of an exemplary communication system 100 for an MDB-compatible vending machine. As implemented in the presently described exemplary embodiment, the system 100 depicted in FIG. 1 includes a vending machine controller (VMC) 104, a change machine/system 114, a physical relay connector 116, an LED display 120, and a door lock connector 118, which is operably connected to the VMC 104. In one embodiment, the VMC 104 can be implemented as an embedded computer or computing device (see item 2 in FIG. 1) within a vending machine.

As shown in FIG. 1, the VMC 104 comprises a DEX output 106, a switch selection input 110, and an MDB/EXE output 108 configured to communicate with the change machine 114 using the MDB protocol 112. In one embodiment, the physical relay connector 116 can be a physical relay connector (see item 4 in FIG. 1) developed by a manufacturer of the vending machine.

According to embodiments, the selection panel 102 can include buttons (item 1 in FIG. 1) and can be embodied as a screen display, a touch screen connected to a vending machine, or as the display of a mobile computing device. In embodiments, the mobile computing device allows a user or consumer to use nearly any mobile computing device to make item selections and purchases from an MDB-compatible vending machine. The mobile computing device can be, but is not limited to, a Personal Digital Assistant (PDA), a tablet computing device, an MP3 player, an iPhone™, an iPod™, an iPad™, a device operating the Android operating system (OS) from Google Inc., a device running the Microsoft™ Windows® Mobile OS, a device running the Microsoft Windows® Phone OS, a device running the Symbian OS, a device running the webOS from Hewlett Packard, Inc., a mobile phone, a BlackBerry® device, a smartphone, a hand held computer, a netbook computer, a palmtop computer, a laptop computer, an ultra-mobile PC, a portable gaming system, a gaming console, or another similar type of mobile computing device or player having a capability to make electronic item selections and purchases from a vending machine.

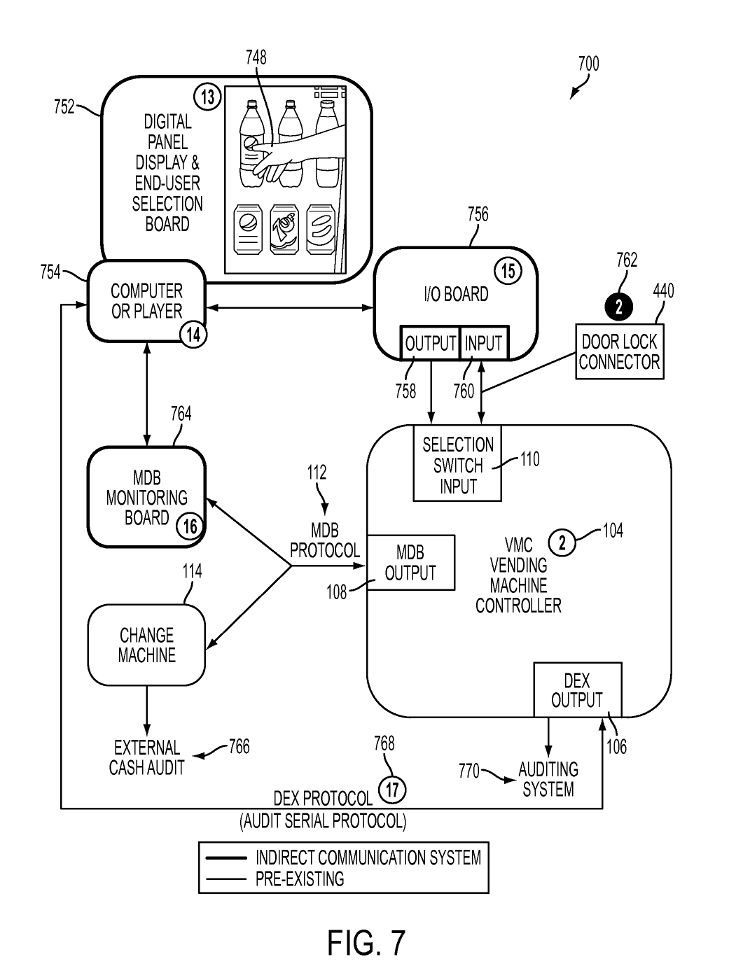

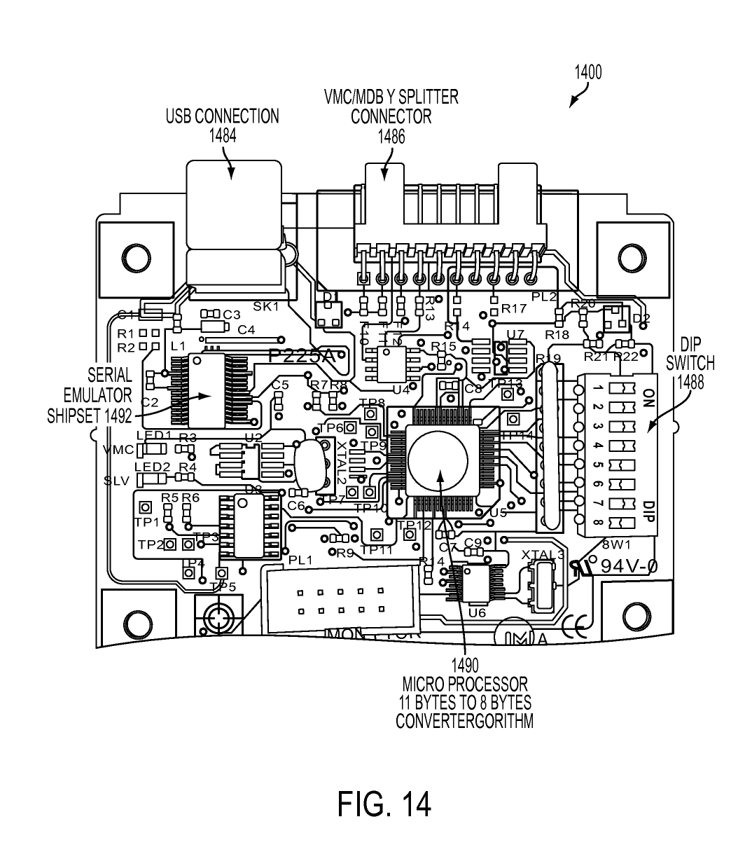

In embodiments, information that can provided through the selection panel 102 to the consumer can include one or more of the following: machine status such as, but not limited to, machine ready to deliver items; item availability/inventory status (e.g., ‘sold out’); the machine's availability; a status indicating whether exact change is required or not; change machine 114 information such as item's price; amount of money inserted; change; and purchase process information. According to embodiments, the purchase process information can be obtained by interfacing with an MDB monitoring board 764 or 1400 as described below with reference to FIGS. 7 and 14, respectively.

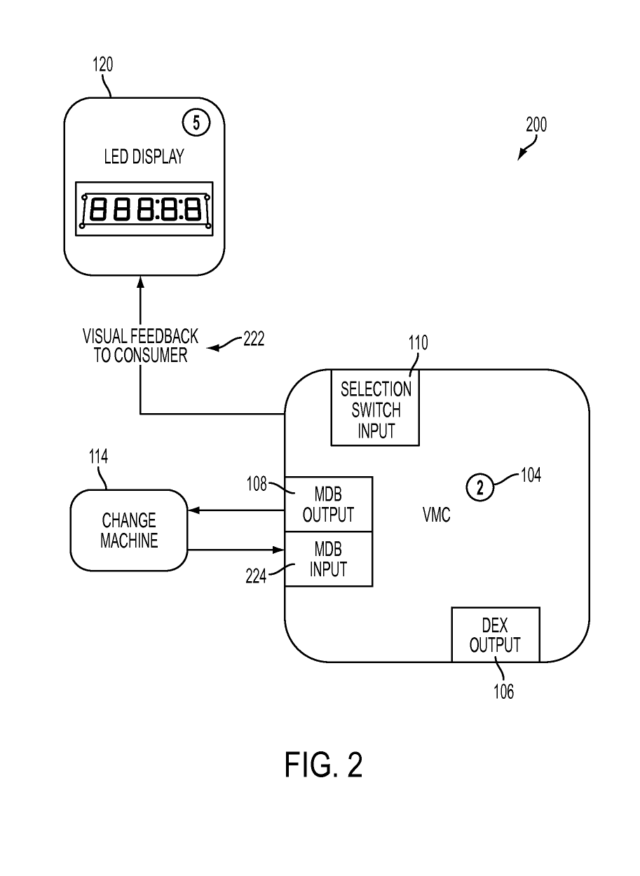

In accordance with embodiments, the communications system 100 can be modified to connect to and communicate with the displays, systems, architectures, processes, controls and components depicted in FIGS. 2-14 and described below. Exemplary sub combinations of components, boards, architectural elements, and processes illustrated in FIGS. 1-14 are described in the following paragraphs.

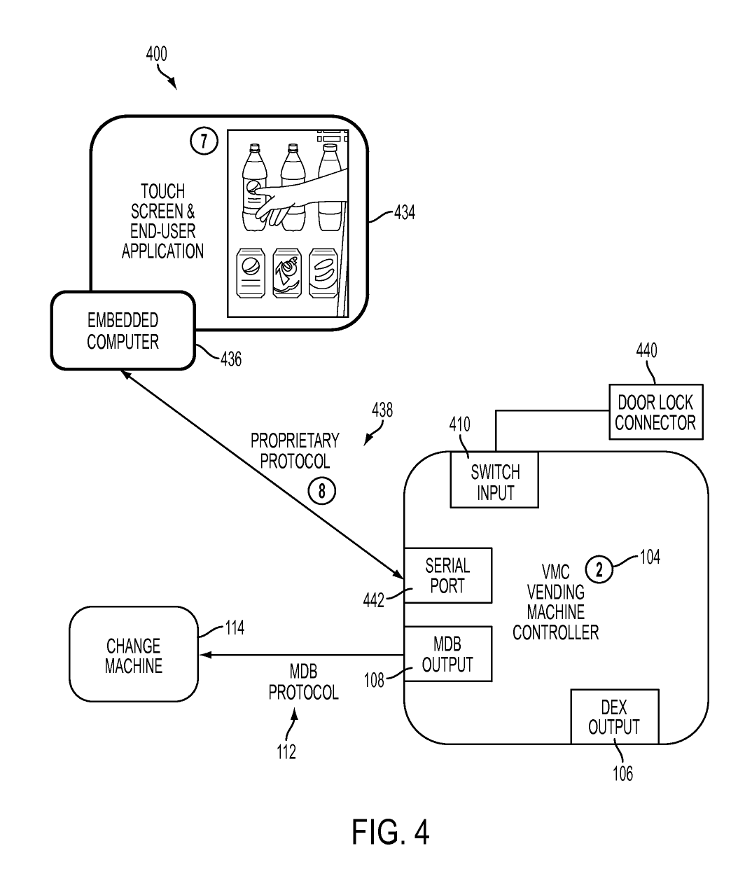

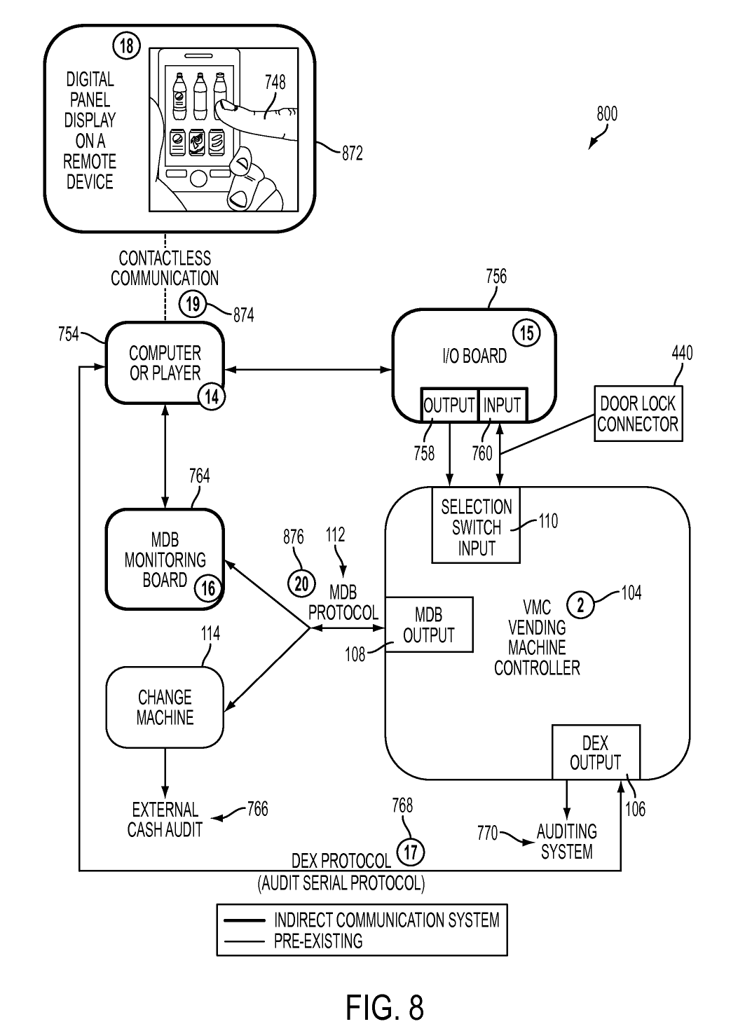

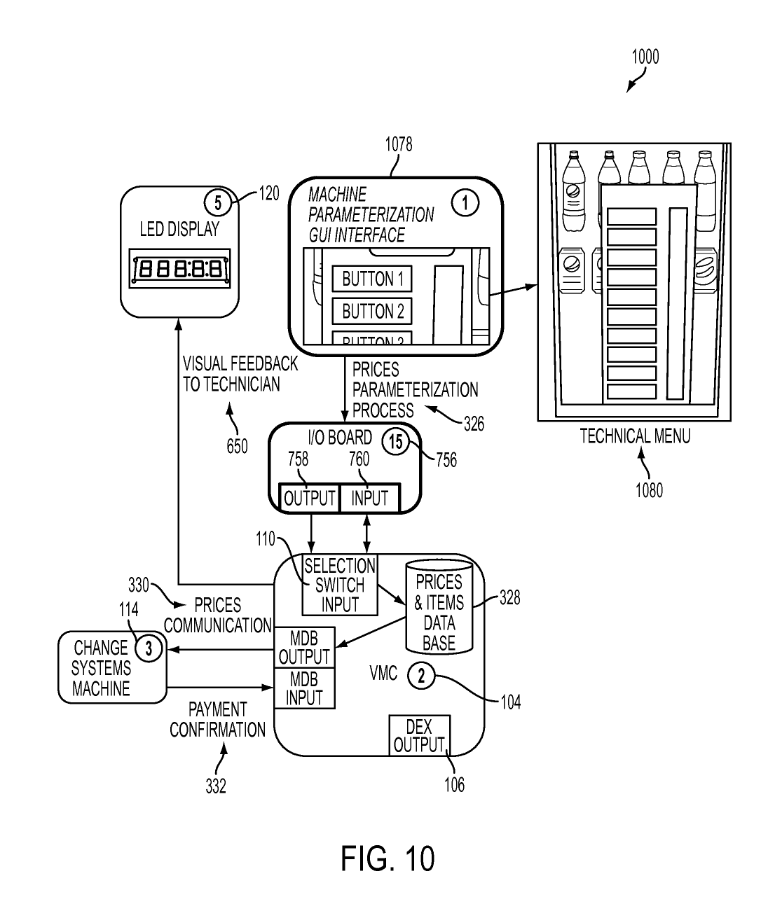

Throughout FIGS. 1-14, displays and panels are shown such as the selection panel 102, the LED display 120, a touch screen 434 (see FIG. 4), an end-user display 752 (see FIG. 7), a remote panel display 872 (see FIG. 8), a machine parameterization interface 1078 (see FIG. 10), and a technical menu 1080 (see FIG. 10). As illustrated in FIGS. 1-13, these displays, screens, and interfaces can include graphical user interfaces (GUIs). As would be appreciated by a person skilled in the relevant art, the GUIs can include hyperlinks, command regions, tabs, buttons, switches, checkboxes, and data entry fields, which are used to initiate actions, invoke routines, enter data, view data, or invoke other functionality, such as selecting and purchasing items. For brevity, only the differences occurring within the figures, as compared to previous or subsequent ones of the figures, are described below.

FIG. 2 is a diagram of an LED display system 200. FIG. 2 is described with continued reference to the embodiment illustrated in FIG. 1. However, FIG. 2 is not limited to that embodiment.

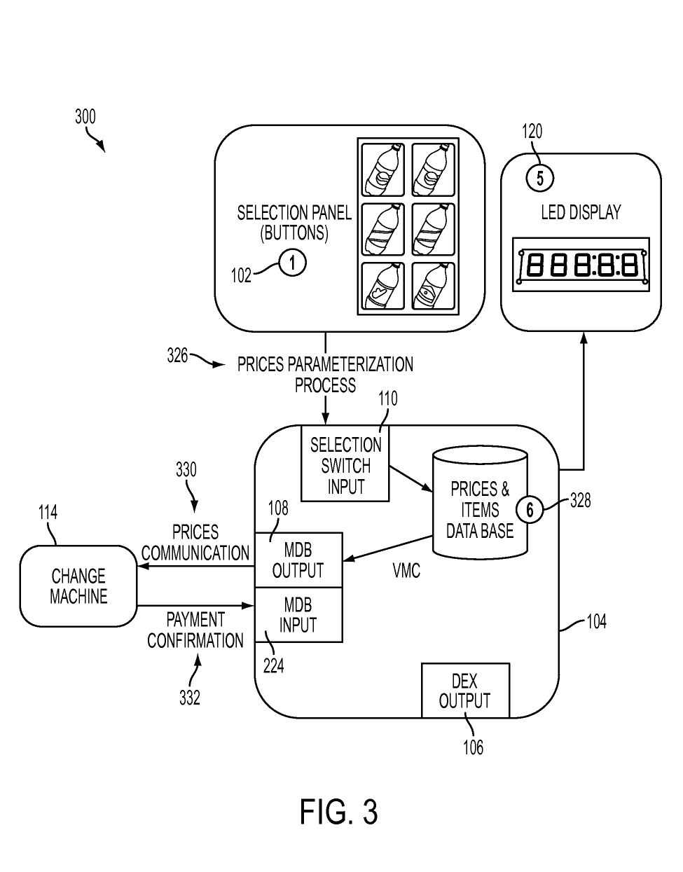

As shown in FIG. 2, the LED display system 200 includes a VMC 104 with an MDB input 224 capable of receiving communications from a change machine 114. By forwarding the received communications from the VMC 104 to the LED display 120, the LED display system 200 depicted in FIG. 2 can provide visual feedback 222 to a consumer via messages rendered (see item 5 in FIG. 3) on the LED display 120. According to an embodiment the visual feedback 222 can be produced in real time by a feedback module configured to interpret the data collected by a collection module and to provide feedback to an end-user of a computing device.

FIG. 3 is a diagram of a price parameterization system 300. FIG. 3 is described with continued reference to the embodiments illustrated in FIGS. 1 and 2. However, FIG. 3 is not limited to those embodiments.

In the exemplary embodiment of FIG. 3, the price parameterization system 300 is controlled collected by a VMC 104.

As shown in FIG. 3, based on selections made via selection panel 102, a prices parameterization process 326 is performed so that the price(s) of one or more selected items can be forwarded to the VMC 104. In the exemplary embodiment of FIG. 3, parameters representing prices of the selected one or more items are received and processed by the selection switch input 110 at the VMC 104. These parameters with price information are then forwarded to a prices and items database 328. In one embodiment, the prices and items database 328 is a relational database hosted by the VMC 104 that maps selected items and their associated parameters to current prices. The prices and items database 328 includes a plurality data records (see item 6 in FIG. 3) representing the mapping of items to parameters and prices. Although the prices and items database 328 is depicted in FIG. 3 as being hosted locally by the VMC 104, it is to be understood that in alternative embodiments, the prices and items database 328 can be hosted on another computing device remote from the VMC 104. The VMC 104 can then forward price information from the prices and items database 328 to the MDB output 108.

With continued reference to FIG. 3, the VMC 104 can communicate item price information 330 to a change machine 114 via an MDB output 108. Similarly, the change machine 114 can return a payment confirmation 332 to the VMC 104 via the MDB input 224.

FIG. 4 is a diagram of a direct communication system 400. FIG. 4 is described with continued reference to the embodiments illustrated in FIGS. 1-3. However, FIG. 4 is not limited to those embodiments.

The direct communication system 400 is configured to communicate between a digital signage device, such as the touch screen 434 or a display similar to the one depicted in FIG. 4, and the VMC 104. In an embodiment, communication in the direct communication system 400 comprises a camera and computer vision detection technologies to enable interaction similar to that provided by the touch screen 434. For example, the direct communication system 400 can use motion sensing input devices, such as, but not limited to the Kinect device from Microsoft™ to accept item selection and payment input from Kinect-compatible devices such as portable game players and computing devices running a Microsoft™ Windows® operating system. As shown in FIG. 4, the touch screen 434 can be embodied as a display of an end-user application (see item 7 in FIG. 4) executing on an embedded computer 436. Using a proprietary protocol 438, the VMC 104 can communicate with the embedded computer 436 via a serial port 442 on the VMC 104.

In embodiments the proprietary protocol 438 can be one of the protocols (see item 8 in FIG. 4) used by Intel, Fuji and V-Sync as part of their intelligent vending concept or by Samsung's uVending platform. Such platforms were designed with direct communication via proprietary protocols 438 between the VMC 104 and a large touch screen, such as the touch screen 434.

With continued reference to FIG. 4, in direct communication system 400, a switch input 410 on the VMC 104 can receive an indication from a door lock connector 440. In this way, the VMC 104 can receive communications indicating whether or not a lock of a vending machine is open.

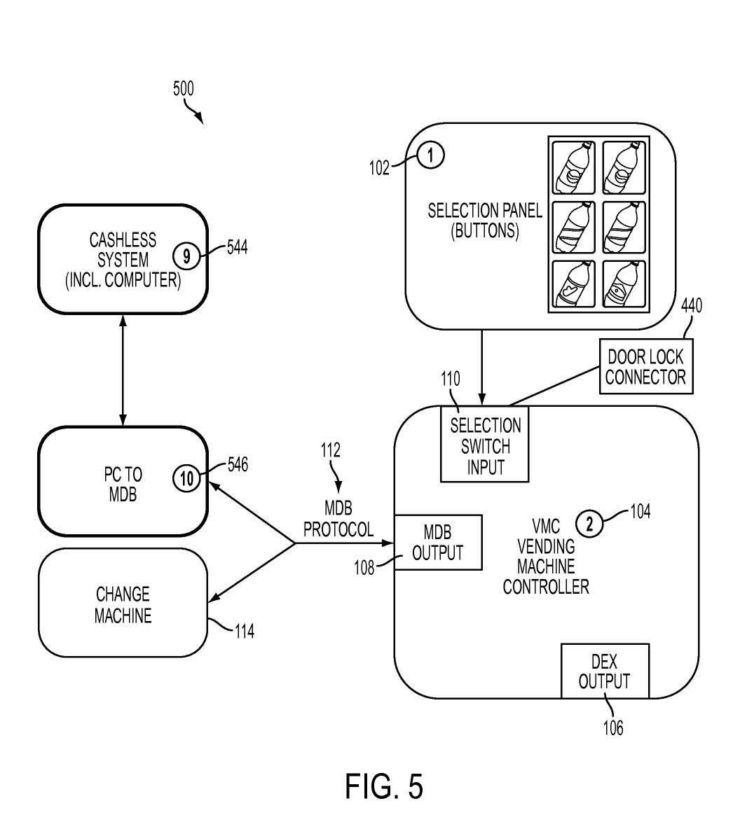

FIG. 5 is a diagram of an indirect communication system 500. According to an embodiment, the indirect communication system 500 can be used to process cashless and contactless payments from a cashless system 544. FIG. 5 is described with continued reference to the embodiments illustrated in FIGS. 1-4. However, FIG. 5 is not limited to those embodiments.

The indirect communication system 500 complies with the MDB protocol 112. As shown in FIG. 5, the cashless system 544 can include a computing device (see item 9 in FIG. 5) and is configured to communicate with the VMC 104 using the MDB protocol 112 via a PC to MDB communication module 546. In an embodiment, the PC to MDB communication module 546 is configured to convert payment information received from the VMC 104 as MDB-compliant communications into a format that the cashless payment system 544 can understand. For example, the PC to MDB communication module 546 may translate or map MDB-protocol communications in order to convey payment information such as the purchase amount to the cashless system 544 so that the cashless system 544 (or its included computing device—item 9) can be used to select a payment method such as a credit card account for payment. In one embodiment, the PC to MDB communication module 546 can be embodied as a commercially available interface (see item 10 in FIG. 5), such as, but not limited to, a PC2MDB™ card that allows a computer to act as a slave device for the VMC 104.

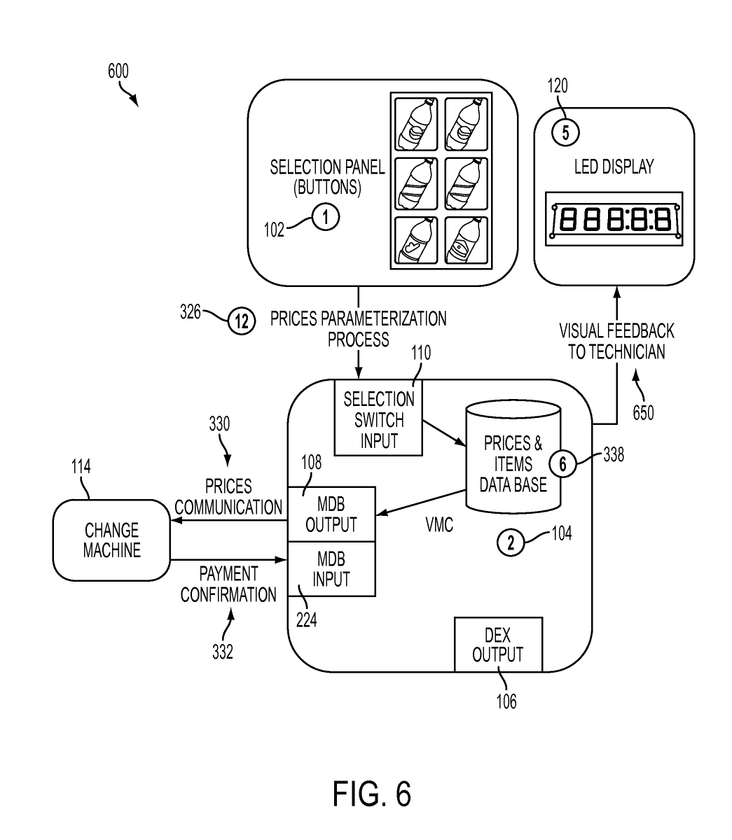

FIG. 6 illustrates a price parameterization process 600. FIG. 6 is described with continued reference to the embodiments illustrated in FIGS. 1-5. However, FIG. 6 is not limited to those embodiments.

As shown in FIG. 6, by executing the price parameterization process 600, the VMC 104 can receive price parameter information 326 produced by a price parameterization module (see item 12 in FIG. 6). The price parameter information 326 is produced by the price parameterization module based upon items selected at the selection panel 102 and is then passed to the selection switch input 110 on the VMC 104. Then, the VMC 104 can provide visual feedback 650 to a technician, vendor using a traditional LED display 120.

With continued reference to FIG. 6, in order to set prices in the VMC 104 prices and items database 328, numerical buttons selected at the selection switch input 110 can be used by a technician or vendor in addition to the LED display 120 visual feedback 650. Other vending machine parameters can be set up through numerical button combinations selected at the selection panel 102 without using the LED display 120 to present visual feedback 650.

FIG. 7 is a block diagram of a digital display communication architecture 700 for MDB-compatible machines. FIG. 7 is described with continued reference to the embodiments illustrated in FIGS. 1-6. However, FIG. 7 is not limited to those embodiments.

FIG. 7 depicts an embodiment wherein the selection panel 102 is a large screen digital panel display (see item 13) integrated in an end-user display 752. The end-user display 752 is interfaced with a computing device (see item 14), such as a smart phone, tablet, portable computer or MP3 player, referred to herein as a computer or player 754, which is in turn connected to a MDB monitoring board 764 and a relay card (see item 15 in FIG. 7) or input/output (I/O) board 756 themselves connected to the VMC 104 through existing connectors (see output 758, input 760 and MDB output 108). It is to be understood that the MDB monitoring board 764 can be implemented in hardware as a card (see item 16 in FIG. 7).

In an embodiment, architecture 700 enables price checking or automatic price initialization of the computer or player 754, the computer or player 754 is connected to the VMC 104 via an existing DEX protocol connector 768.

The computer or player 754 can launch both ad-hoc or unscheduled audits and periodic audit requests. Such audit requests are sent from the computer or player 754 to the VMC 104 via the DEX protocol connector 768 and trigger invocation of DEX data collection by an auditing system 770, which in turn produces the requested DEX audit. As shown in FIG. 7, the DEX protocol connector 768 uses an audit serial protocol to communicate DEX data (see item 17). Although it will stop a vending machine during a requested sales transaction or process, the computer or player 754 can use the DEX protocol connector 768 to electronically collect vending audit information from the auditing system 770. The auditing system 770 may translate the audit information into workable information that can be understood by the computer or player 754 prior to transmission via the DEX protocol 768. Such information can comprise prices per item and the number of sales on a per item basis. Once the computer or player 754 has collected the price items information, it can initialize the price to be shown or displayed to a consumer through the end-user display 752. According to an embodiment, the computer or player 754 can be configured to routinely check item prices from one or more periodic audits produced by the auditing system 770.

As illustrated in FIG. 7, the MDB monitoring board 764 can be configured to monitor the VMC 104 through communications sent using the MDB protocol 112 from the MDB output 108 via a Y splitter. With reference to FIG. 5, an indirect communications system 500 can route communications between the MDB output 108 on the VMC 104, a change systems and machines 114 such as a coin system, bill validator or a cashless system 544.

Item prices can be duplicated in an end user selection interface displayed on the end-user panel display 752 without accessing to the VMC 104 prices and items database 328 and to the LED display 120 during a price setting process. In one embodiment, the prices parameterization process 326 parameterizes the prices in the prices and items database 328 hosted by the VMC 104.

With continued reference to FIG. 7, another embodiment consists of collecting data communicated via the DEX protocol connector 768 as part of a requested DEX audit. This procedure advantageously ensures reliable price matches between the VMC 104 and the computer or player 754. In this way, each time the corresponding vending machine is unlocked and re-locked, and/or end user application price modifications appear, the VMC 104 754 DEX audit procedure can be launched to re-initialize (i.e., populate and/or update) data records in the prices and items database 328. After the prices and items database 328 has been re-initialized, the updated price data can also be communicated toe the computer or player 754 via the DEX output 106 using the DEX protocol 768.

In an embodiment of communication architecture 700, physical buttons of the selection panel 102 are replaced by a digital panel display 752 including an end-user application executing on the computer or player 754. An end-user 748 (i.e., a consumer) can then select items using the end-user display 752. The end-user's 748 selection information is processed by the computer or player 754 until an item order is passed to the I/O board 756. Once an item order is passed to the I/O board 756 via input port 760, the information is sent to the VMC's 104 election switch input 110 via the I/O board's 756 output port 758.

An embodiment reconstructs information so that the LED display 120 can present visual feedback 650 information without assistance from the VMC 104. To implement this embodiment, the MDB monitoring board 764 is configured to continuously provide machine status and change system information to the computer or player 754 through the MDB protocol 112. In one embodiment, the MDB protocol 112 is compliant with a multi-drop bus/internal communication protocol (MDB/ICP) specification, such as, but not limited to, version 3.0 of the MDB/ICP specification.

As depicted in FIG. 14, the MDB monitoring board 764 can be implemented as a hardware card specifically designed in order to both support an MDB/ICP protocol and to provide required data to the computer or player 754 and the VMC 104. The required data can be formatted or tailored for specific software simulating change systems and change machines 114 whose functions include interpreting MDB information monitored by the MDB monitoring board 764.

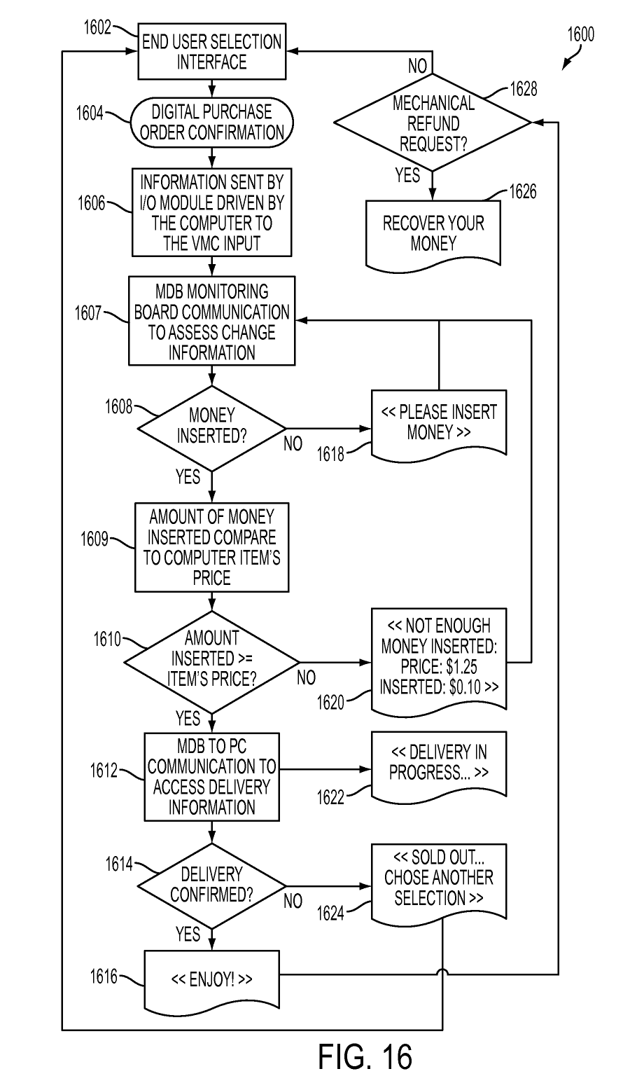

The method described below with reference to the flowchart of FIG. 16 describes steps for a process enabling the display of MDB-interpreted information from the digital panel display and the end-user display 752 to compare to the information displayed by the machine LED display 120.

In an exemplary configuration of the communication architecture 700, once the door locking and unlocking information 762 from the door lock connector 440 indicates that the vending machine is locked, only the digital panel display and the end-user display 752 will provide feedback to the end-user 748. In response to detecting that the vending machine is unlocked, the LED display 120 provides visual feedback 650 to a technician for vending machine parameterization.

According to the exemplary embodiment of FIG. 7, the computer or player 754 is embedded in the same computing device that presents the end-user display 752.

FIG. 8 is a block diagram of a contactless digital display communication architecture 800 for an MDB compatible machine. FIG. 8 is described with continued reference to the embodiments illustrated in FIGS. 1-7. However, FIG. 8 is not limited to those embodiments.

As shown in the exemplary embodiments of FIGS. 7 and 8, the selection panel 102 can be implemented as either the end-user display 752 or a remote panel display 872 on a remote device (see item 18 in FIG. 8). Both the end-user display 752 and the remote panel display 872 can independently or mutually communicate with the computer or player 754, which is connected to the MDB monitoring board 764 and the I/O board 756. Software modules running on the computer or player 754 can handle priority between different digital panel displays such as the end-user display 752 and the remote panel display 872.

FIGS. 7 and 8 illustrate how architectures 700 and 800 use components of an indirect communications system in conjunction with pre-existing components. For example, as shown in FIG. 8, the pre-existing VMC 104 can exchange contactless data 876 with the MDB monitoring board 764 using a pre-existing communications connection (see item 20). With continued reference to FIGS. 7 and 8, the change machine 114 and the door lock connector 440 are the other pre-existing components included in architectures 700 and 800. The architectures 700 and 800 also include components of an indirect communications system. As shown in FIGS. 7 and 8, the MDB monitoring board 764, which handles communications between the computer or player 754 and the I/O board 756, is part of the indirect communications system along with the I/O board 756, the computer or player 754, and the end-user display 752.

In another embodiment, the remote panel display 872 is rendered on a portable, digital display device (see item (18) in FIG. 8). The portable device can be embodied as one or more of a smart phone, MP3 reader/player, or a tablet. As shown in FIG. 8, when the portable device is in close proximity to the vending machine, the vending machine and the portable device communicate through existing, standard contactless protocols to complete contactless communications 874. Such protocols (see item (19) in FIG. 8) can comply with the Bluetooth®, Wi-Fi™, or another suitable contactless, wireless standard. As described above with reference to FIG. 7, the computer or player 754 itself is connected to the MDB monitoring board 764 and the I/O board 756.

As shown in FIG. 8, in response to receiving a selection of one or more items in a remote display 872 of a remote device, the remote device can initiate contactless communications 874 with a computer or player 754. According to an embodiment, the remote display 872 is implemented as a touch screen display on a mobile computing device. In an embodiment, the contactless communications 874 are passed from an NFC-enabled mobile computing device such as, but not limited to a smart phone or tablet to an NFC panel or terminal on the receiving computing or player 754.

After the computer or player 754 receives the contactless communications 874, information regarding the selected item and/or payment can be passed to an I/O board 756 and the MDB monitoring board 764. The MDB monitoring board 764 can then forward contactless data 876, after it has been converted to comply with the MDB protocol 112, to the VMC 104.

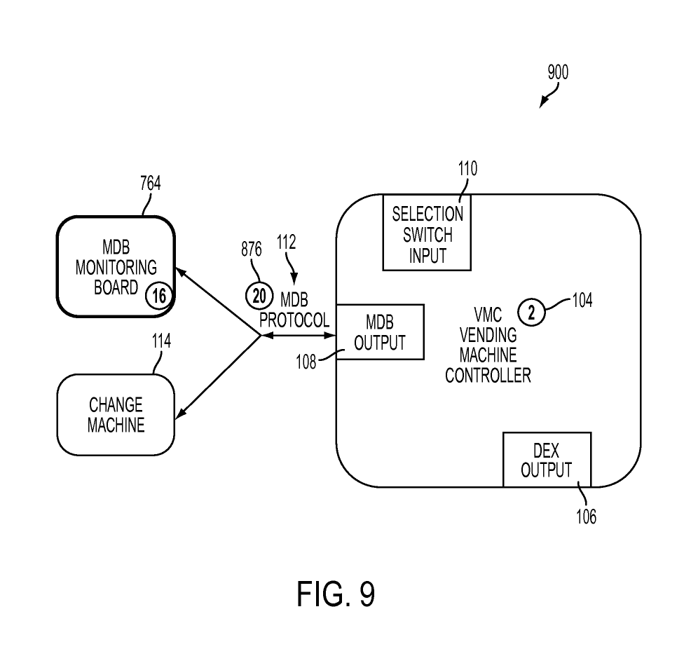

FIG. 9 is a diagram of a system using a Y wire loom (i.e., a splitter) in order to monitor MDB communications. FIG. 9 is described with continued reference to the embodiments illustrated in FIGS. 1-8. However, FIG. 9 is not limited to those embodiments.

In an embodiment, the Y wire loom can be used to send communications complying with the MDB protocol 112 from the MDB output 108 on the VMC 104 to both the MDB monitoring board 764 and the change machine (or change system) 114. As shown in the exemplary embodiment of FIG. 9, such communications can include the contactless data 876 described above with reference to FIG. 8. In this way, the VMC 104 can check payment information through the existing MDB output 108 connection with connected change systems 114. In embodiments, the change machine or system 114 can include a coin validator, a bill/currency validator, and a cashless payment authorizer. By using the Y wire loom depicted in FIG. 9, communications with the change machine 114 can occur in parallel with communications to the MDB monitoring board 764, which monitors communications based on the MDB protocol 112 between the VMC 104 and the change machine 114.

FIG. 10 depicts parameterization 1000 of machine and price numerical buttons. FIG. 10 is described with continued reference to the embodiments illustrated in FIGS. 1-9. However, FIG. 10 is not limited to those embodiments.

As shown in FIG. 10 and with reference to FIG. 7, door locking and unlocking information 762 detected by the door lock connector 440 can be monitored by the computer or player 754 in order to switch from displaying an end user selection application in the end-user display 752 to a technical menu 1080. Such door locking and unlocking information 762 can be provided by interfacing the door lock connector 440 with the I/O board 756. The I/O board 756 can also be used to simulate selection of physical buttons as a result of selections in the technical menu 1080.

In an embodiment, a selection panel 102 having physical buttons is replaced with a digital panel display such as the end-user display 752, which is used to select items. In this embodiment, vending machine parameterization usually done via a combination of physical buttons in order to enter a technical menu (i.e., when the vending machine door is opened) is replaced by virtual, numerical buttons rendered on a digital panel display as part of the technical menu 1080 depicted in FIG. 10. As shown in FIG. 10, the technical menu 1080 receives vending machine parameterization resulting from input and selections made in the machine parameterization GUI interface 1078.

FIG. 10 also depicts an embodiment wherein the change machine 114 can be implemented as a change system (see item 3 in FIG. 10). Accordingly, it is to be understood that references to the change machine 114 in this document encompass a change system with one or more components configured to carry out the functionalities of the change machine 114.

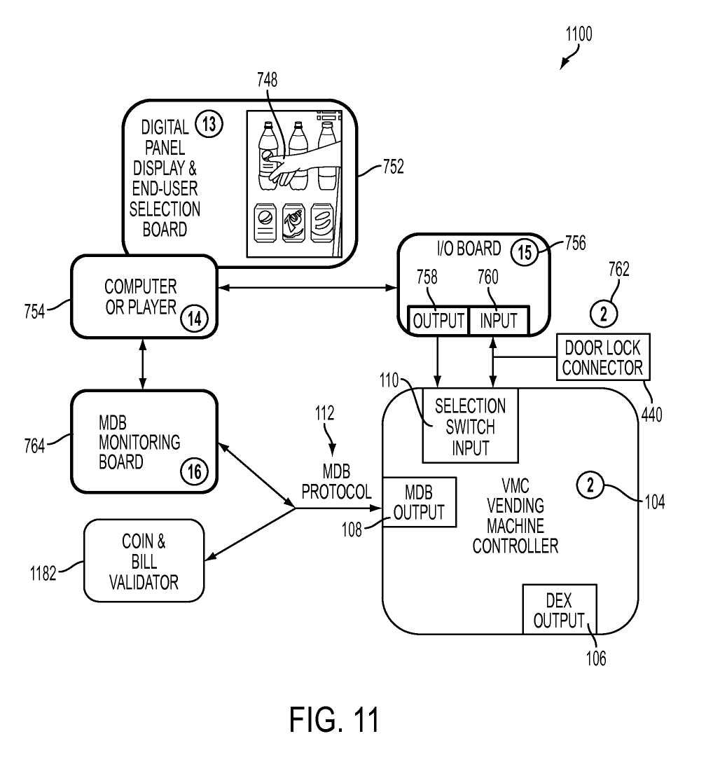

FIG. 11 is a diagram of a system 1100 for providing door locking connector information. FIG. 11 is described with continued reference to the embodiments illustrated in FIGS. 1-10. However, FIG. 11 is not limited to those embodiments.

In system 1100, the I/O board 756 receives door locking and unlocking information 762 at its input port 760 and then communicates the door locking and unlocking information 762 to the selection switch input 110 of the VMC 104.

System 1100 communicates the door locking and unlocking information 762 detected by the door lock connector 440 between the VMC 104 and both the MDB monitoring board 764 and a coin and bill validator 1182. As shown in FIG. 11, such communication can sent using the MDB protocol 112 and can be done in parallel using the Y wire loom described above with reference to FIG. 9.

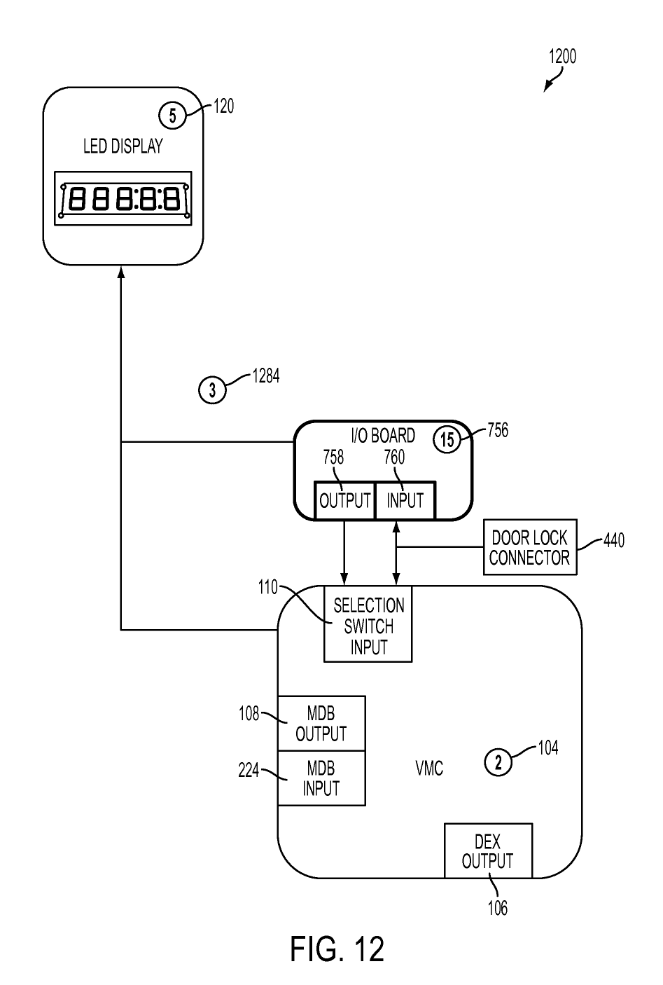

FIG. 12 is a diagram of vending machine with an LED display control 1200. FIG. 12 is described with continued reference to the embodiments illustrated in FIGS. 1-11. However, FIG. 12 is not limited to those embodiments.

The LED display control 1200 provides at least as much feedback to the consumer (i.e., end-user 748) as LED displays 120 used in traditional vending machines do. MDB and machine information can be used to reconstruct price and change information that will be displayed by the selection panel 102.

According to embodiments, a subset of the information described above with reference to FIGS. 1-11 and below can be collected from the VMC 104 and the I/O board 756 and then displayed by the LED display 120 using the LED display control 1200.

For example, the door lock information 762 can be received from the door lock connector 440 and displayed on the LED display 120. In response to receiving an indication from the from the door lock connector 440 that the vending machine is unlocked, the LED display control 1200 can switch on the LED display 120 (or other displayed described above with reference to FIG. 10) controlled by the computer to a technical mode. The LED display control 1200 can also invoke the auditing system 770 to launch a DEX audit once the door lock connector 440 sends door lock information 762 indicating that the vending machine door lock has been relocked. In this way, a DEX audit of the price can enable conciliation between a price set the LED display 120 or another digital display described above and the VMC 104. For example, this information can be displayed in the selection panel 102 in order to calculate the amount of money to be inserted or remaining.

In another embodiment, the door locking and unlocking information 762 can also be used to activate or deactivate the current LED display 120 via a connection 1284 between the LED display 120 and the I/O board 756. As shown in FIG. 12, the connection 1284 can be implemented as a hardware connector (see item 3).

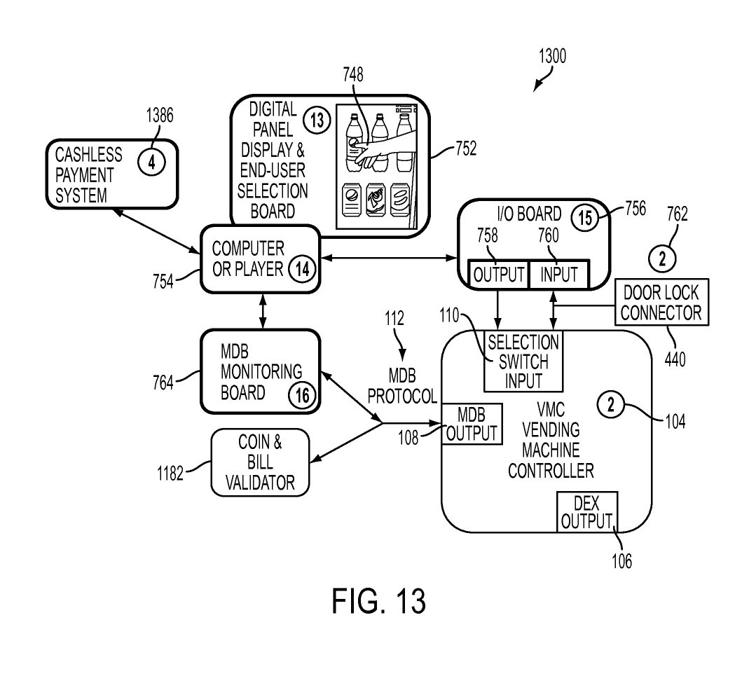

FIG. 13 is a block diagram of a cashless payment system 1300. FIG. 13 is described with continued reference to the embodiments illustrated in FIGS. 1-12. However, FIG. 13 is not limited to those embodiments.

In an embodiment, the cashless system 1300 enhances the systems and architectures described above with reference to FIGS. 1-12 by adding to the MDB monitoring board 764 the ability to send MDB payment information to the VMC 104 in order for the computer or player 754 to act as a cashless payment device 1386.

According to the exemplary embodiment depicted in FIG. 13, the cashless payment system 1300 includes a cashless payment device 1386 configured to communicate with a computer or player 754. According to an embodiment, the cashless payment device 1386 is coupled to an end-user display 752 of a remote mobile device, such as a smart phone, via the computer or player 754. In accordance with this embodiment, the cashless system 1300 can communicate with the computer or player 754 via an existing NFC standard (possibly in the form of a tag or an NFC panel or chip installed in or attached to the computer or player 754). It is to be understood that communications can be established between the computer or player 754 and the cashless payment device 1386 using other commercially-available “off the shelf” (COTS) technologies, such as, but not limited to RFID tags, so that the cashless system 1300 can be used to select and pay for items.

As described above with reference to FIG. 7, the computer or player 754 is in turn able to communicate with an MDB monitoring board 764, which can communicate with the VMC 104 using the MDB protocol 112 using a Y wire loom. In this way, the computer or player 754 can act as the cashless payment device 1386.

FIG. 14 depicts an exemplary MDB monitoring card 1400. FIG. 14 is described with continued reference to the embodiments illustrated in FIGS. 1-13. However, FIG. 14 is not limited to those embodiments.

Exemplary functionalities and specifications for the MDB monitoring card 1400 described below. Additionally, the MDB board 764 described above with reference to FIG. 7 can be implemented as the MDB monitoring card 1400 depicted in FIG. 14.

The MDB monitoring card 1400 is a circuit board configured to enable traffic on a vending machine MDB “bus” to be simply monitored on a computing device (i.e., a personal computer) using a serial protocol. The serial emulator chipset 1492 on the MDB monitoring card 1400 can be used to facilitate such monitoring via a serial protocol.

One function of the MDB monitoring card 1400 is to transform 11-bytesignals compliant with the MDB protocol 112 into an 8-byte signal interpretable by a computing device. As illustrated in FIG. 14, a microprocessor 1490 on the MDB monitoring card 1400 can be configured to perform the 11 byte to 8-byte conversion using a converter algorithm (i.e., the ‘convertergorithm’ of FIG. 14). It is to be understood that in an embodiment, the converter algorithm can be implemented as firmware executing on the microprocessor 1490.

As shown in FIG. 14, DIP switches 1488 on the MDB monitoring card 1400 are electric switches that enable traffic for certain MDB devices (such as, but not limited to, a coin and bill validator 1182, a first payment/credit card reader, a second card reader, etc.) to be specifically included or excluded. The VMC/MDB Y splitter connector 1486 depicted in FIG. 14 can be used to connect the MDB monitoring card 1400 to a Y wire loom, such as the Y wire loom described above with reference to FIG. 9. In this way, the VMC/MDB Y splitter connector 1486 can be used to facilitate MDB communications between the MDB output 108 on a VMC 104 to both the MDB monitoring board 1400 and a change machine (or change system) 114.

In an embodiment, serial data sent by the MDB monitoring card 1400 to the computing device is in the form of a single line of ASCII-HEX data relating to a single command from the VMC 104. In this embodiment, the ASCII-HEX data is in two or three parts depending on the type of message. The first part can include a command from the VMC 104, and the second part can include a response to the VMC 104 from an MDB peripheral. The third part can be an Acknowledgement (ACK) from the VMC 104 if the peripheral has sent any data. For example, a ‘coin change giver’ from a change machine (or change system) 114 can send ASCII-HEX data as follows: 0909/030044050200F0010101010102040A14288F:00

In the above example, the ASCII-HEX data comprises a setup command 09H, checksum 09H from the VMC 104, an 03H 28H configuration response from a coin change giver, a checksum 8FH, and finally OOH, which is an ACK from the VMC 104 in response to receiving the data.

With continued reference to FIG. 14, a Universal Serial Bus (USB) connection 1484 on the MDB monitoring card 1400 can be used to connect it to other USB-compliant devices via a USB bus.

### METHOD EMBODIMENTS

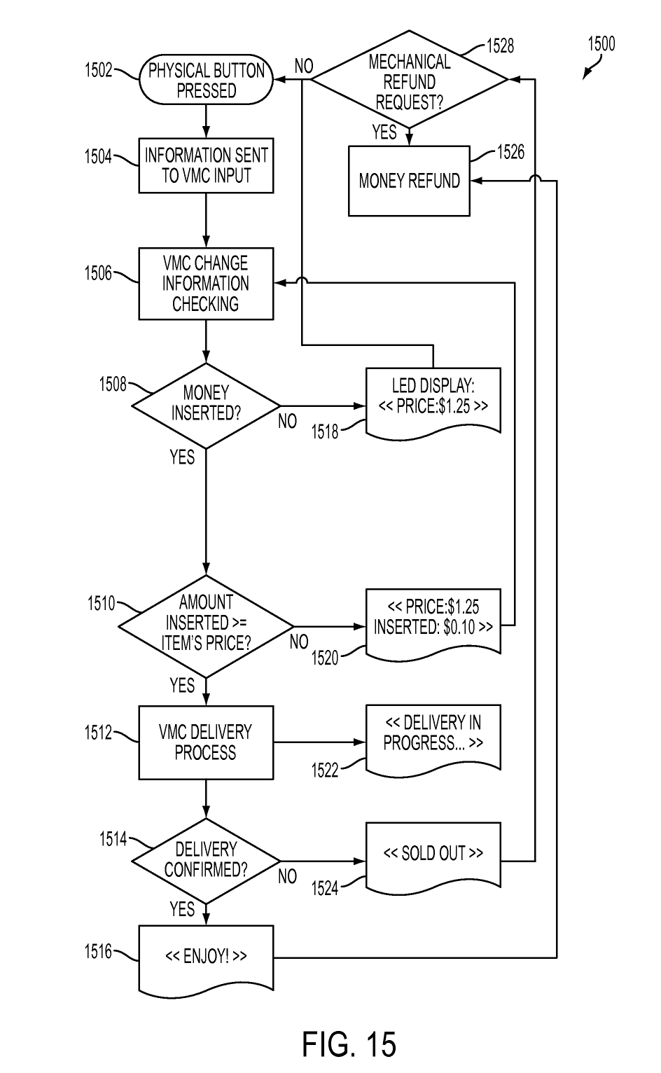

FIGS. 15 and 16 are flowcharts illustrating steps by which LED displays provide vending machine feedback. In particular FIG. 15 is a flowchart illustrating steps of a method for using a physical LED display to provide vending machine feedback and FIG. 16 is a flowchart illustrating steps of a method 1600 for using a virtual LED display to provide vending machine feedback. FIGS. 15 and 16 are described with continued reference to the embodiments illustrated in FIGS. 1-14. However, FIGS. 15 and 16 are not limited to those embodiments.

In the workflow described above with reference to FIGS. 1-14, the VMC 104 can provide feedback to an end-user 748 via the LED display 120 by using the method 1500.

The method 1500 begins in step 1502 when a selection of an item is received. In the exemplary embodiment of FIG. 15, the selection is received in response to a physical button being pressed. In one embodiment, step 1502 is initiated in response to a selection made using selection panel 102. Alternatively, step 1502 can be initiated upon receipt of item selections from the touch screen 434, or the end-user display 752.

After receiving the item selection, the method 1500 proceeds to step 1504 where the received item selection information is sent the VMC 104. In an embodiment, the selection information is sent to the selection switch input 110 of the VMC 104. After the selection information is sent to the VMC 104, control is passed to step 1506.

In step 1506, the VMC 104 checks change information. Such change information can include checking for item price and availability changes in the prices and items database 328. After the change information has been checked, control is passed to step 1508.

In step 1508, a determination is made as to whether the end-user 748 has inserted money. Although this step is depicted as determining whether money has been inserted into a vending machine, as described above, it is to be understood that ‘money insertion’ in the presently disclosed systems, architectures and methods can encompass detecting cashless, contactless payments in addition to the presentation by an end-user of a credit card, debit card, or pre-paid ‘gift’ card to pay for a selected item. For example, step 1508 can entail determining if the magnetic stripe of a physical card has been scanned by the vending machine or if a NFC-enabled payment device has been used for payment. If it is determined that end-user 748 has inserted money, control is passed to step 1510. If it is determined that the end-user 748 has inserted money, control is passed to step 1518, where the LED display 120 indicates the price for the selected item.

In step 1510, a determination is made as to whether the amount of money or payment detected in step 1508 is sufficient to pay for the selected item. If it is determined that the end-user 748 has inserted enough money or proffered a sufficient payment to pay for the selected item, control is passed to step 1512. If it is determined that the end-user 748 has not inserted enough money, control is passed to step 1520, where the LED display 120 indicates that additional payment is needed for the selected item.

In step 1512, a delivery process is performed for the selected and paid for item by the VMC 104. In an optional embodiment, if a pre-determined period of time passes after the delivery process is initiated, but prior to completing the delivery, control is passed to step 1522 where the LED display 120 indicates that delivery is in progress for the selected item and control is passed back to step 1512. After the delivery process is attempted, control is passed to step 1514.

In step 1514, a determination is made as to whether the delivery attempted in step 1512 was confirmed for the selected item. If it is determined that the delivery was confirmed for the selected item, control is passed to step 1516 where the LED display 120 displays a message for the end-user 748 confirming the delivery before passing control to step 1526. If it is determined that the delivery could not be confirmed, control is passed to step 1524, where the LED display 120 displays a message conveying the reason the selected item could not be delivered before passing control to step 1528. In the exemplary embodiment of FIG. 15, the reason displayed in step 1524 is that the selected item was unavailable (i.e., sold out).

In step 1526, a money refund is processed. In the case of a successful, confirmed item delivery, this step comprises refunding any over-payment for the selected item (i.e., if exact change was not inserted by the end-user 748). If the delivery was not successful, step 1526 refunds the full payment.

In step 1528, a determination is made as to whether a request for a refund has been received. If it is determined that a request for a refund has been received (i.e., as a mechanical request based on input from an end-user at a selection panel 102), control is passed to step 1526 where the money refund is processed and method 1500 ends. If it is determined that no request for a refund has been received, control is passed to back step 1502, where the end-user 748 can start method 1500 again by selecting a different, available item.

In the workflow described above with reference to FIGS. 1-14, the VMC 104 can provide feedback to an end-user 748 via a virtual LED display by using the method 1600. Method 1600 is a process enabling the display of MDB-interpreted information from a digital panel display, such as the end-user display 752, as compared to the method 1500 described above, which uses the LED display 120.

The method 1600 begins in step 1602 when a selection of an item is received. In the exemplary embodiment of FIG. 16, the selection is received in response to a selection in an interface (i.e., a GUI). In one embodiment, step 1602 is initiated in response to a selection made using a remote panel display 872. Alternatively, step 1602 can be initiated upon receipt of item selections from the touch screen 434, or the end-user display 752.

After receiving the selection, the method 1600 proceeds to step 1604 where a digital purchase order confirmation is performed before passing control to step 1606.

In step 1606, the confirmed digital purchase order information is sent by an I/O module executing on a computing device, to the VMC 104. In an embodiment, the selection information is sent to the selection switch input 110 of the VMC 104 by the I/O board 756. After the digital purchase order information is sent to the VMC 104, control is passed to step 1607.

In step 1607, the MDB monitoring board 764 initiates communication to assess change information. Such change information can include checking for item price and availability changes in the prices and items database 328. After the change information has been assessed, control is passed to step 1608.

In step 1608, a determination is made as to whether the end-user 748 has inserted money. As described above with reference to method 1500, although this step is depicted as determining whether money has been inserted into a vending machine, it is to be understood that money insertion as used herein can encompass detecting cashless, contactless payments in addition to the presentation of a credit card, debit card, or pre-paid ‘gift’ card to pay for a selected item. For example, step 1608 can entail determining if the magnetic stripe of a physical card has been scanned by the vending machine or if a NFC-enabled payment device such as a Radio-frequency identification (RFID) tag, key fob, or key tag has been used for payment. If it is determined that end-user 748 has inserted money, control is passed to step 1609. If it is determined that the end-user 748 has not inserted money, control is passed to step 1618, where the virtual LED display prompts the end-user 748 by indicating the price for the selected item.

In step 1609, the amount of money inserted or the payment proffered is compared to the selected item's price. In the exemplary embodiment illustrated in FIG. 16, this step is performed by a computing device configured to compare the payment amount to the item's price. This step can comprise comparing the payment to the item's price in the prices and items database 328. After the payment has been compared to the item's price, control is passed to step 1610.

In step 1610, a determination is made as to whether the amount of money or payment compared in step 1609 is sufficient to pay for the selected item. If it is determined that the end-user 748 has inserted enough money or proffered a sufficient payment to pay for the selected item, control is passed to step 1612. If it is determined that the end-user 748 has not inserted enough money, control is passed to step 1620, where the virtual LED display (i.e., on end-user display 752) indicates that additional payment is needed for the selected item.

In step 1612, communication is initiated by the PC to MDB communication module 546 to access delivery information. According to an optional embodiment, if a pre-determined period of time has passed after the communication initiated, but prior to completing the delivery, control is passed to step 1622 where the virtual LED display indicates that delivery is in progress for the selected item and control is passed back to step 1612. After the delivery information is accessed, control is passed to step 1614.

In step 1614, a determination is made as to whether the delivery information accessed in step 1612 indicates that delivery was confirmed for the selected item. If it is determined that the delivery was confirmed for the selected item, control is passed to step 1616 where the Virtual LED display (or end-user display 752) displays a message for the end-user 748 confirming the delivery before passing control to step 1628. If it is determined that the delivery could not be confirmed, control is passed to step 1624, where the Virtual LED display (or end-user display 752) displays a message conveying the reason the selected item could not be delivered and prompting the end-user 748 to choose another selection, before passing control back to step 1602, where the end-user 748 can start the method 1600 again by selecting a different, available item. In the exemplary embodiment of FIG. 16, the reason displayed in step 1624 is that the selected item was unavailable (i.e., sold out).

In step 1628, a determination is made as to whether a request for a refund has been received. If it is determined that a request for a refund has been received (i.e., as a mechanical request based on input from an end-user at the selection panel 102 or the end-user display 752), control is passed to step 1626 where the money refund is processed and method 1600 ends. If it is determined that no request for a refund has been received, control is passed to back step 1602, where the end-user 748 can start method 1600 again by selecting a different, available item.

In step 1626, a money refund is processed. In the case of a successful, confirmed item delivery, this step comprises refunding any over-payment for the selected item (i.e., if exact change was not inserted by the end-user 748). If the delivery was not successful, step 1626 refunds the full payment.

### Computer System Implementation

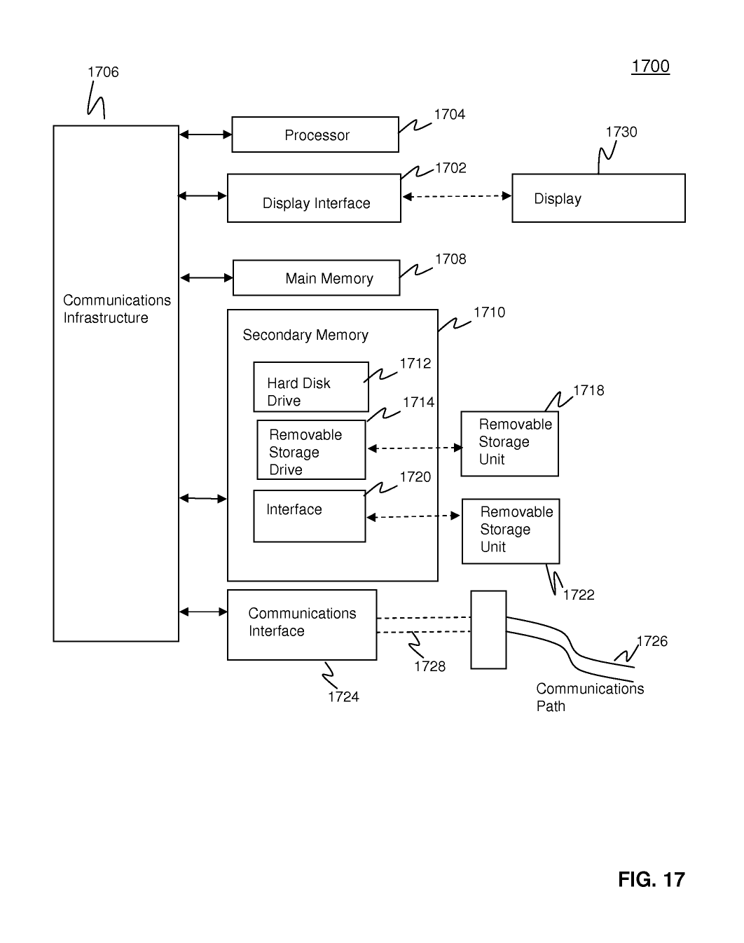

As would be appreciated by someone skilled in the relevant art(s) and described below with reference to FIG. 17, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on VMC 104, change machine 114, embedded computer 436, computer/player 754, cashless system 544, auditing system 770, coin and bill validator 1182, MDB monitoring board 764, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

Aspects of the present disclosure shown in FIGS. 1-16, or any part(s) or function(s) thereof, may be implemented using hardware, software modules, firmware, tangible computer readable media having instructions stored thereon, or a combination thereof and may be implemented in one or more computer systems or other processing systems.

FIG. 17 illustrates an example computer system 1700 in which embodiments of the present disclosure, or portions thereof, may be implemented as computer-readable code. For example, the systems 100, 400, 500, and 1300, the architectures 700 and 800 of FIGS. 1, 4, 5, 7, 8, and 13, the MDB monitoring board 1600 depicted in FIG. 14, and the methods 1500 and 1600 of FIGS. 15 and 16 can be implemented in computer system 1700 using hardware, software, firmware, non-transitory computer readable media having instructions stored thereon, or a combination thereof and may be implemented in one or more computer systems or other processing systems. Hardware, software, or any combination of such may embody any of the modules and components used to implement the systems and architectures of FIGS. 1, 4, 5, 7, 8, and 13. Similarly, hardware, software, or any combination of such may embody modules and components used to implement the processes of FIGS. 3, 6 and 10 and the methods of FIGS. 15 and 16.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the present disclosure are described in terms of this example computer system 1700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1704 may be a special purpose or a general purpose processor device. As will be appreciated by persons skilled in the relevant art, processor device 1704 may also be a single processor in a multi-core/multiprocessor system, such system operating alone, or in a cluster of computing devices operating in a cluster or server farm. Processor device 1704 is connected to a communication infrastructure 1706, for example, a bus, message queue, network, or multi-core message-passing scheme.

Computer system 1700 also includes a main memory 1708, for example, random access memory (RAM), and may also include a secondary memory 1710. Secondary memory 1710 may include, for example, a hard disk drive 1712, removable storage drive 1714. Removable storage drive 1714 may comprise a floppy disk drive, a magnetic tape drive, an optical disk drive, a flash memory, or the like.

The removable storage drive 1714 reads from and/or writes to a removable storage unit 1718 in a well-known manner. Removable storage unit 1718 may comprise a floppy disk, magnetic tape, optical disk, etc. which is read by and written to by removable storage drive 1714. As will be appreciated by persons skilled in the relevant art, removable storage unit 1718 includes a non-transitory computer usable storage medium having stored therein computer software and/or data.

In alternative implementations, secondary memory 1710 may include other similar means for allowing computer programs or other instructions to be loaded into computer system 1700. Such means may include, for example, a removable storage unit 1722 and an interface 1720. Examples of such means may include a program cartridge and cartridge interface (such as that found in video game devices), a removable memory chip (such as an EPROM, or PROM) and associated socket, and other removable storage units 1722 and interfaces 1720 which allow software and data to be transferred from the removable storage unit 1722 to computer system 1700.

Computer system 1700 may also include a communications interface 1724. Communications interface 1724 allows software and data to be transferred between computer system 1700 and external devices. Communications interface 1724 may include a modem, a network interface (such as an Ethernet card), a communications port, a PCMCIA slot and card, or the like. Software and data transferred via communications interface 1724 may be in the form of signals, which may be electronic, electromagnetic, optical, or other signals capable of being received by communications interface 1724. These signals may be provided to communications interface 1724 via a communications path 1726. Communications path 1726 carries signals and may be implemented using wire or cable, fiber optics, a phone line, a cellular/wireless phone link, an RF link or other communications channels.

In this document, the terms “computer program medium,” “non-transitory computer readable medium,” and “computer usable medium” are used to generally refer to tangible media such as removable storage unit 1718, removable storage unit 1722, and a hard disk installed in hard disk drive 1712. Signals carried over communications path 1726 can also embody the logic described herein. Computer program medium and computer usable medium can also refer to memories, such as main memory 1708 and secondary memory 1710, which can be memory semiconductors (e.g. DRAMs, etc.). These computer program products are means for providing software to computer system 1700.

Computer programs (also called computer control logic) are stored in main memory 1708 and/or secondary memory 1710. Computer programs may also be received via communications interface 1724. Such computer programs, when executed, enable computer system 1700 to implement the present disclosure as discussed herein. In particular, the computer programs, when executed, enable processor device 1704 to implement the processes of the present disclosure, such as the steps in the methods illustrated by FIGS. 15 and 16, discussed above. Accordingly, such computer programs represent controllers of the computer system 1700. Where the present disclosure is implemented using software, the software may be stored in a computer program product and loaded into computer system 1700 using removable storage drive 1714, interface 1720, and hard disk drive 1712, or communications interface 1724.

Embodiments of the present disclosure also may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A system for controlling a multi-drop bus (MDB)-compatible vending machine, comprising:
a selection module configured to communicate a selection of an item received from a computing device having a display to a vending machine controller (VMC) of the vending machine;
a collection module configured to collect MDB information from the VMC and a change system; and
a feedback module configured to interpret the data collected by the collection module and to display feedback, based on the collected data, on a digital display.

2. The system of claim 1, wherein the collection module is further configured to exchange information, using an MDB protocol and an MDB output of the VMC, with an MDB monitoring board in parallel with the change system.

3. The system of claim 2, wherein the information is exchanged using a Y wire loom or splitter.

4. The system of claim 2, wherein the MDB monitoring board is configured to read communications sent via the MDB protocol from both from the change system and the VMC.

5. The system of claim 2, wherein:
the computing device is configured to receive and interpret communications received from the MDB monitoring board using the MDB protocol; and
the feedback module is further configured to display real time feedback based on the interpreted communications on the display of the computing device.

6. The system of claim 1, wherein the selection module is further configured to simulate selection of an item as a selection made via a switch button at a selection switch input of the VMC.

7. The system of claim 1, further comprising an auditing system configured to collect Data EXchange (DEX) information in order produce audits of the vending machine, wherein the vending machine can be used while the audits are being produced.

8. The system of claim 7, wherein the audits are performed periodically or an ad-hoc basis.

9. The system of claim 7, further comprising a database storing item price and inventory information,
wherein the VMC is configured to use the audits to update the price and inventory information by:
initializing item and price information;
reinitializing item and price information; and
reconstructing monetary information.

10. The system of claim 1, wherein a light-emitting diode (LED) display of the vending machine can be disconnected and the feedback module is further configured to display the feedback on the display of the computing device.

11. The system of claim 1, wherein the computing device is remote from the vending machine and can act as a cashless payment device.

12. The system of claim 11, wherein the computing device is one or more of a smart phone, tablet computer, or an MP3 player.

13. The system of claim 1, wherein the computing device is remote from the vending machine and can act as a contactless item selection device.

14. The system of claim 13, wherein the computing device is one or more of a smart phone, tablet computer, or an MP3 player.

15. The system of claim 1, wherein the computing device can receive DEX information.

16. A method for providing feedback from a vending machine, the method comprising:
receiving a selection of an item;
confirming a digital purchase order for the selected item;
forwarding the confirmed digital purchase order to a vending machine controller (VMC) of the vending machine;
assessing change information for the digital purchase order, wherein the assessing is based at least on price and availability changes for the selected item in a prices and items database;
determining if sufficient payment has been received at the vending machine for the selected item, wherein the determining is based on comparing a received payment to a price retrieved for the selected item from the prices and items database;
initiating communication, by a communication module to access item delivery information;
determining, based on the delivery information, if a delivery is confirmed for the selected item; and
in response to determining that the delivery is not confirmed, displaying a message on a display of a computing device conveying the reason the selected item could not be delivered and prompting for an alternate another selection.

17. The method of claim 16, wherein the selection is received in response to a selection in a graphical user interface (GUI) of a computing device remote from the vending machine; and further comprising:
in response to receiving a request for a refund in the GUI, refunding:
an overpayment for a delivered item; or
a full payment for an undeliverable item.

18. The method of claim 16, wherein the payment includes one or more of:
a cashless payment;
a contactless payment;
a credit card payment;
a debit card payment; or
a pre-paid gift card payment.

19. The method of claim 16, further comprising, after initiating communication, in response to determining that a pre-determined period of time has passed, displaying, on a display of a computing device, an indication that delivery is in progress for the selected item.

20. A non-transitory computer readable storage medium having program instructions stored thereon for providing real time feedback from a vending machine, executable on a computing device, the instructions comprising
instructions for receiving a selection of an item;
instructions for confirming a digital purchase order for the selected item;
instructions for forwarding the confirmed digital purchase order to a vending machine controller (VMC) of the vending machine;
instructions for assessing change information for the digital purchase order, wherein the assessing is based at least on price and availability changes for the selected item in a prices and items database;
instructions for determining if sufficient payment has been received at the vending machine for the selected item, wherein the determining is based on comparing a received payment to a price retrieved for the selected item from the prices and items database;
instructions for initiating communication, by a communication module to access item delivery information;
instructions for determining, based on the delivery information, if a delivery is confirmed for the selected item; and
in response to determining that the delivery is not confirmed, instructions for displaying a message on a display of a computing device conveying the reason the selected item could not be delivered and prompting for an alternate another selection.
